(19) United States
(12) Patent Application Publication
(10) Pub. No.: US 2013/0318017 A1
(43) Pub. Date: Nov. 28, 2013

(54) Devices for Learning and/or Decoding Messages, Implementing a Neural Network, Methods of Learning and Decoding and Corresponding Computer Programs

(71) Applicants: Claude Berrou, Locmaria Plouzane (FR); Vincent Gripon, Brest (FR)

(72) Inventors: Claude Berrou, Locmaria Plouzane (FR); Vincent Gripon, Brest (FR)

(73) Assignee: INSTITUT TELECOM - TELECOM BRETAGNE, Brest (FR)

(21) Appl. No.: 13/818,879

(22) PCT Filed: Aug. 25, 2011
(86) PCT No.: PCT/EP2011/064605

§ 371 Date: Aug. 12, 2013

(30) Foreign Application Priority Data
Aug. 25, 2010 (FR) 1056760

(51) Int. Cl. G06N 3/08

(52) U.S. Cl. CPC G06N 3/08
USPC 706/16

(57) ABSTRACT

A learning and decoding technique is provided for a neural network. The technique involves using a set of neurons, referred to as beacons, wherein said beacons are binary neurons capable of assuming only two states, an on state and an off state. The beacons are distributed in blocks of a predetermined number of beacons and being allocated for processing a sub-message. Each beacon is associated with a specific occurrence of the sub-message. Learning includes splitting a message into B sub-messages to be learned, where B is greater than or equal to two; activating, for a sub-message, a single beacon in each block to be in the on state, all of the other beacons of the block being in the off state; and activating binary connections between the on beacons of each of the block for a message to be learned, which assume only connected and disconnected states.

### CROSS-REFERENCE TO RELATED APPLICATIONS

This application is a Section 371 National Stage Application of International Application No. PCT/EP2011/064605, filed Aug. 25, 2011 and published as WO 2011/025583 on Mar. 1, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of neural networks. More specifically, the disclosure relates to the implementing of neural networks and especially to learning by such networks and decoding by means of such networks, especially for the recognition of messages or for discrimination between learned messages and non-learned messages.

### BACKGROUND OF THE DISCLOSURE

1. Artificial Intelligence

Since half a century ago, in fact since the famous Dartmouth Conference in 1956 organized by John McCarthy, artificial intelligence and its potential applications have drawn the interest of numerous scientists. However, apart from a few modest successes in hardware achievements (formal neural networks, Hopfield networks, perceptrons, fuzzy logic and evolved automatons), the goals of artificial intelligence have been essentially related to the designing of what are called expert systems, i.e. software programs capable of reproducing decisions that a human expert could take with respect to a limited problem with a set of restricted criteria and in a well-circumscribed context.

The expression “artificial intelligence” has gone out of fashion and been replaced by that of “cognitive sciences”, the main tool of which remains the classic computer whose architecture and the operation are, as is well known, far removed from those of the brain. Despite all the efforts accomplished in the past 20 years in the exploration of biological neural networks through increasingly sophisticated methods (electro-encephalography, magnetic resonance imaging, etc), the brain remains unknown territory from the viewpoint of information processing.

2. Hopfield Network

Encoding in neural networks can be approached especially through associative Hopfield memories (see for example: John J. Hopfield (2007) Hopfield Network. Scholarpedia, 2(5):1977), which are very simple to build and are a reference in the field.

A Hopfield network, an example of which is given in FIG. 1 (in the case of a classic Hopfield network with n=8 neurons), is represented by a complete undirected graph with n vertices (neurons) and without loops. The graph therefore comprises

$$\frac{n ( n - 1 )}{2} = 28$$

links and the two-way link between the vertices i and j is characterized by a (synaptic) weight wᵢⱼ. This weight results from the learning of M messages of n binary antipodal values (±1), each value dᵢ^{m} (i=1 . . . n) of m^{th} message (m=1 . . . M) corresponding to a same value of the i^{th} neuron. wᵢⱼ is given by:

$${w}_{ij} = \frac{1}{M} {\sum }_{{m = 1}_{i \neq j}}^{M} {d}_{i}^{m} {d}_{j}^{m} \qquad ( 1 )$$

and can take P=M+1 values.

The remembering or recollection of a particular message from a part of its content is done through the iterative process described by the following relationships, where vᵢ^{p} is the output value of the i^{th} neuron after the p^{th} iteration:

$${v}_{i}^{p} = + 1 if {\sum }_{{j = 1}_{j \neq i}}^{n} {w}_{ij} {v}_{j}^{p - 1} \geq 0 \\ {v}_{i}^{p} = - 1 if {\sum }_{{j = 1}_{j \neq i}}^{n} {w}_{ij} {v}_{j}^{p - 1} < 0 \qquad ( 2 )$$

An upper boundary of diversity of learning and error-free remembering by such a machine is:

$${M}_{ma x} = \frac{n}{log ( n )} \qquad ( 3 )$$

(Natural Logarithm)

where Mₘₐₓ is the number of independent patterns of n bits that the neural network can learn as explained by R. J. McEliece, E. C. Posner, E. R. Rodemich, and S. S. Venkatesh, in “The Capacity of the Hopfield Associative Memory,” IEEE Trans. Inform. Theory, Vol. IT-33, pp. 461-482, 1987.

This boundary Mₘₐₓ is relatively low and limits the value of the Hopfield networks and their applications. For example, with 1900 neurons and therefore 1.8.10⁶ binary connections, a Hopfield network is capable of acquiring and remembering only about 250 messages of 1900 bits.

### SUMMARY

An exemplary aspect of the present disclosure relates to a device for learning messages, implementing a neural network comprising a set of neurons, called beacons.

According to an exemplary embodiment the invention, this device comprises a set of neurons, called beacons, said beacons being binary neurons, capable of taking only two states, an “on” state and an “off” state,

said beacons being distributed into blocks each comprising a predetermined number of beacons, each block of beacons being assigned to the processing of a sub-message, each beacon being associated with a specific occurrence of said sub-message,
and means for learning by said neural network, comprising:
means for sub-dividing a message to be learned into B sub-messages to be learned, B being greater than or equal to two;
means for activating a single beacon in the “on” state in each block, for a sub-message to be learned, all the other beacons of said block being in the “off” state;
means for creating connections between beacons, activating, for a message to be learned, connections between the “on” beacons of each of said blocks, said connections being binary connections, capable of taking only a connected state and a disconnected state.

Thus, an embodiment of the invention relies especially on sparse learning, where only one beacon per block can be “on” for each message to be learned, simplifying the processing operation and offering high storage capacity. The learning and the decoding are then very simple and reliable since it is known that, in each block, only one beacon is “on” for a given message.

The processing operations are also simplified as compared with the neural networks with real values or weighted values because it relies on a binary approach: on the one hand, the beacons are binary neurons capable of taking only two states, and on the other hand the connections between the “on” beacons are also binary connections that can take only one connected state and one disconnected state.

According to at least one embodiment, said messages have a length k=Bκ where B is the number of blocks and κ the length of a sub-message, each block comprising l=2^{κ} beacons.

According to a first approach, the messages can be binary messages, constituted by a set of bits. According to a second approach, they can be messages consisting of symbols belonging to a predetermined finite alphabet. In this case, the number l of beacons of each block corresponds (at the minimum) to the number of symbols of this block.

A device for learning of this kind can especially be made in the form of at least one integrated circuit and/or implanted in software form in an apparatus such as a computer comprising data-storage means and data-processing means.

An embodiment of the invention also pertains to a device for decoding a message to be decoded by means of a neural network configured by means of the device for learning described here above. Such a decoding device comprises:
means for sub-dividing the message to be decoded into B sub-messages to be decoded;
means for turning on the beacons associated respectively with said sub-messages to be decoded, in the corresponding blocks;
means for associating, with said message to be decoded, a decoded message as a function of said “on” beacons.

It must be noted that the learning and decoding devices can be distinct devices (physically or through their software implementation) or can be grouped together in a single learning and decoding device.

According to one particular aspect of an embodiment of the invention, said means for associating can implement a maximum likelihood decoding.

This approach, known in the field of information technologies, gives good decoding results in combination with the proposed sparse encoding.

Thus, said decoding means can comprise means of local decoding, for each of said blocks, activating in the “on” state at least one beacon that is the most likely beacon in said block, as a function of the corresponding sub-message to be decoded, and delivering a decoded sub-message as a function of the connections activated between said beacons in the “on” state.

Said decoding means can also include overall decoding means fulfilling a message-passing function in taking account of the set of beacons in the “on” state.

In this case especially, said decoding means can implement an iterative decoding performing at least two iterations of the processing done by said local decoding means.

According to another particular aspect of at least one embodiment, said means for associating implement processing neurons organized so as to determine the maximum value of at least two values submitted at input.

There is thus available a neural implementation which for example can be implemented in the form of at least one basic module constituted by six zero-threshold neurons and with output values 0 or 1, comprising:
a first neuron capable of receiving a first value A;
a second neuron capable of receiving a second value B, at least one among said first value A and second value B being positive or zero;
a third neuron, connected to the first neuron by a connection with a weight of 0.5 and to the second neuron by a weight of 0.5;
a fourth neuron connected to the first neuron by a connection with a weight of 0.5 and to the second neuron by a connection with a weight of −0.5;
a fifth neuron connected to the first neuron by a connection with a weight of −0.5 and to the second neuron by a connection with a weight of 0.5;
a sixth neuron connected to the third, fourth and fifth neurons by connections with a weight of 1 and delivering the maximum value between the values A and B.

Such a decoding device can especially be made in the form of at least one integrated circuit. It can also be a computer or be implanted entirely or partly in a computer or more generally in an apparatus comprising data-storage means and data-processing means.

An embodiment of the invention also pertains to a method for learning by the neural networks used in the devices as described here above. Such a method for learning implements a set of neurons, called beacons, said beacons being binary beacons, capable of taking only two states, an “on” state and an “off” state, said beacons being distributed into blocks each comprising a predetermined number of beacons, each block of beacons being allocated to the processing of a sub-message, each beacon being associated with a specific occurrence of said sub-message.

This method for learning comprises a phase of learning comprising the following steps for a message to be learned:
a step for sub-dividing a message to be learned into B sub-messages to be learned, B being greater than or equal to two;
a step for activating a single beacon in the “on” state in each block, for a sub-message to be learned, all the other beacons of said block being in the “off” state;
a step for creating connections between beacons, activating, for a message to be learned, connections between the “on” beacons of each of said blocks, said connections being binary connections, capable of taking only a connected state and a disconnected state.

Preferably, a connection between two beacons possessing the value 1 keeps this value. As already mentioned, an embodiment of the invention therefore uses only binary values to implement this learning process.

An embodiment of the invention also pertains to a computer program product downloadable from a communications network and/or stored on a computer-readable carrier and/or executable by a microprocessor, comprising program code instructions for the execution of this method of learning when it is executed on a computer.

An embodiment of the invention also pertains to a method for decoding a message to be decoded by means of a neural network configured according to the method for learning as described here above and comprising the following steps:
(a) receiving a message to be decoded;
(b) sub-dividing said message to be decoded into B sub-messages to be decoded;
(c) associating, with said message to be decoded, a decoded message as a function of the “on” beacons corresponding to said sub-messages to be decoded.

Said step (c) can thus include, for each of said sub-messages to be decoded, and for each corresponding block of beacons, the sub-steps of:
(c1) initializing, by activating in the “on” state at least one beacon corresponding to the processed sub-message, and extinguishing all the other beacons of said block;
(c2) searching for at least one most likely beacon from among the set of beacons of said block;
(c3) activating, in the “on” state, said at least one most likely beacon, and extinguishing all the other beacons of said block;
   and a step of:
(c4) determining the decoded message corresponding to the message to be decoded, by combination of the sub-messages designated by the beacons in the “on” state.

When an iterative approach is desirable, the method may furthermore comprise a step:
(d) of passing messages between the B blocks, adapting the values of the beacons for a reinsertion at the step (c2),
   said steps (c2) to (c4) being then reiterated.

In this case, during a reiteration, the step (c2) can take account of the pieces of information delivered by the step (c4) and the pieces of information taken into account during at least one preceding iteration.

Thus, a memory effect is introduced.

In particular, said pieces of information taken into account during at least one preceding iteration can be weighted by means of a memory effect coefficient γ.

Besides, according to another aspect, in the step (c3), a most likely beacon can, in certain embodiments, be not activated if its value is below a predetermined threshold σ.

This threshold makes it possible if necessary to avoid turning on a beacon for which there is strong doubt (even if it is the most likely beacon in theory).

An embodiment of the invention can find numerous applications in different fields. Thus, especially, the decoding can deliver, for a message to be decoded:
a decoded message corresponding to the message to be decoded so as to provide for an associative memory function; or
a piece of binary information indicating whether the message to be decoded is or is not a message already learned by said neural network so as to provide a discriminating function.

An embodiment of the invention also pertains to a computer program product downloadable from a communications network and/or stored in a computer-readable carrier and/or executable by a microprocessor, characterized in that it comprises program code instructions for the execution of this decoding method when it is executed on a computer.

### BRIEF DESCRIPTION OF THE DRAWINGS

Other features and characteristics shall appear more clearly from the following description of an exemplary embodiment of the invention, given by way of a simple illustratory and non-restrictive example and from the appended drawings, of which:

FIG. 1, commented upon in the introduction, presents the example of an 8-neuron Hopfield network;

FIG. 2 illustrates the principle of learning diversity in a simplified embodiment implementing four blocks;

FIG. 3 is another representation of a four-block distributed addressing system;

FIG. 4 presents a bipartite graph of the decoding of four words, or sub-messages, by means of the networks of FIG. 2 or 3;

FIG. 5 shows an example of a neural embodiment of the “maximum of two numbers” function, where at least one number is positive or zero;

FIG. 6 is an example of a neural embodiment, on the basis of the principle of FIG. 5, for the selection of the maximum parameter from a number equal to a power of 2 of values, at least one of which is positive or zero;

FIG. 7 illustrates a complex four-block network implementing the scheme of FIG. 5;

FIG. 8 illustrates the error rate for the reading (after a single iteration) of M messages of k=36 bits by a network of B=4 blocks of l=512 neurons, when one of the blocks receives no information, as well as the density of the network;

FIG. 9 presents the error rate for the reading (after four iterations) of M messages de k=64 bits by a network of B=8 blocks of l=256 neurons, when half of the blocks receive no information, as well as the density of the network;

FIG. 10 represents the discard rate, after only one iteration, of any unspecified message when M messages of k=36 bits have been learned by a network of B=8 blocks of l=512 neurons;

FIG. 11 schematically illustrates an implementation of a decoding according to an embodiment of the invention;

FIG. 12 presents an example of learning of a message, in the case of non-binary symbols belonging to a predetermined alphabet.

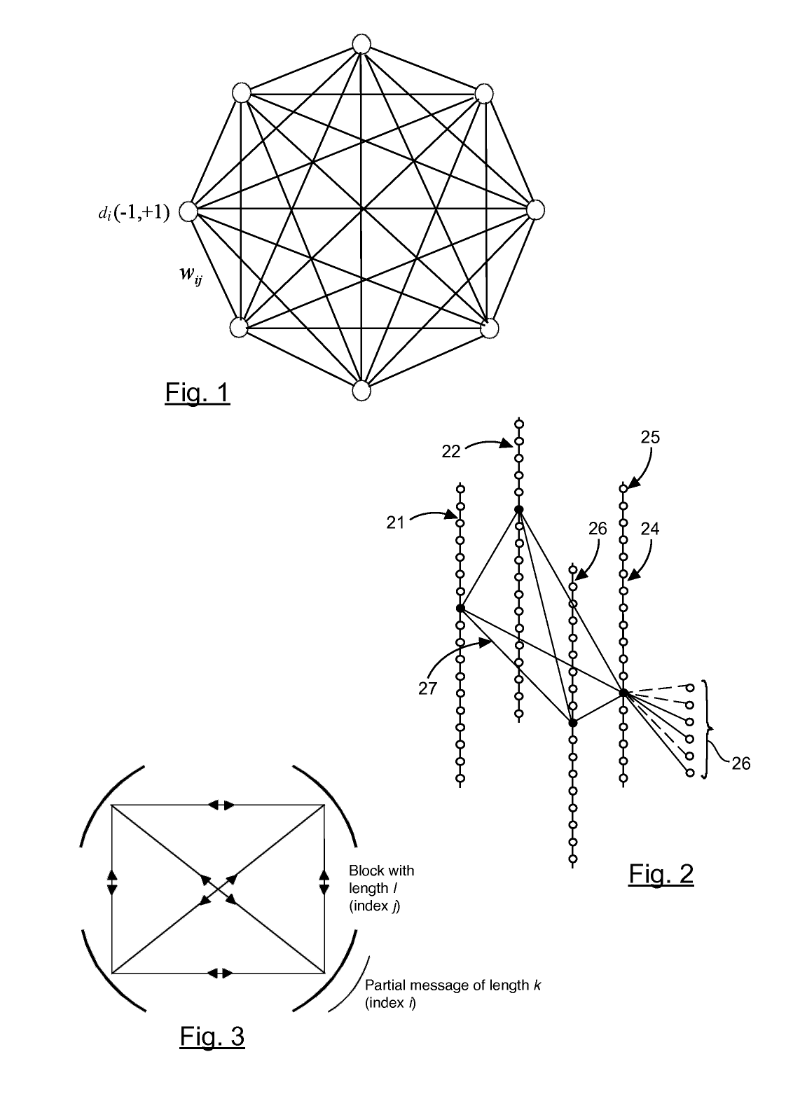

### DETAILED DESCRIPTION OF ILLUSTRATIVE EMBODIMENTS

1. Introduction

An exemplary embodiment of the invention relies on aspects developed in the field of information theory, the developments of which have long been encouraged and harnessed by the requirements of telecommunications, a field that is constantly in search of improvements. Considerable progress has thus been obtained in the writing of information, its compression, protection, transportation and interpretation.

In particular, recent years have seen the emergence of new methods of information processing that rely on probabilistic exchanges within multi-cell machines. Each cell is designed to process a problem locally in an optimal way and it is the exchange of information (probabilities or probability logarithms) between the cells that leads to a generally optimal result.

Turbo-decoding has opened the way to this type of approach (see for example C. Berrou, A. Glavieux and P. Thitimajshima, “Near Shannon limit error-correcting coding and decoding: turbo-codes”, Proc. of IEEE ICC '93, Geneva, pp. 1064-1070, May 1993. See also: Sylvie Kerouédan and Claude Berrou (2010), Scholarpedia, 5(4):6496). Turbo-decoding has been acknowledged as an instance of the very general principle of “belief propagation”; see for example R. J. McEliece, D. J. C. MacKay and J.-F. Cheng, “Turbo decoding as an instance of Pearl's ‘belief propagation’ algorithm”, IEEE Journal on Selected Areas in Commun., vol. 16, no. 2, pp. 140-152, February 1998), which has subsequently found another major application in the decoding of “Low Density Parity Check” codes (LDPC, see for example R. G. Gallager, “Low-density parity-check codes”, IRE Trans. Inform. Theory, Vol. IT-8, pp. 21-28, January 1962).

The inventors have observed that it is possible to try and adapt the developments made in these fields to the use of neural networks in terms of distributed structures, separability of information, resistance to noise, resilience, etc.

2. Sparsity

According to one aspect of an embodiment of the invention, the diversity of learning is increased through sparsity. This principle of sparsity can be implemented both in the length of the messages to be stored (k<n) and in the density of connections in the distributed encoding networks.

To increase learning diversity beyond the value given by the relationship (3), the inventors have developed the following reasoning. The quantity of binary information carried by the connections defined on P levels of a complete graph with n vertices is

$$\frac{n ( n - 1 )}{2} {log}_{2} ( P )$$

giving in practice

$$\frac{{n}^{2}}{2} {log}_{2} ( P )$$

for n as a high value. The number of messages of a length n that this can represent, for example in a Hopfield network, can therefore not exceed

$$\frac{n}{2} {log}_{2} ( P )$$

(the upper boundary given by (3) is smaller because it integrates a criterion of decodability).

If, by appropriate means, the length of the messages is limited to a value k below n, the number of messages M can be increased so long as:

$$M \leq \frac{{n}^{2} {log}_{2} ( P )}{2 k} \qquad ( 4 )$$

The upper boundary of learning diversity is therefore linear in n, for messages of a length n, and quadratic in n for messages of a length k<n. The upper boundary of the capacity (diversity by length) however remains the same. This emphasizes the value of considering methods, in neural networks, for storing messages of lengths far smaller than the size of the networks, as developed here below.

3. Neural Networks with High Learning Diversity

Let us take a network with a binary (0,1) connection of n binary (0,1) neurons. This network is sub-divided into B blocks of l=n/B neurons, called beacon neurons or beacons. Here below, we assume that l is a power of 2 in such a way that each beacon can be addressed by a sub-message of κ=log₂(l) bits. The messages addressed to the network therefore have a length k=Bκ.

FIG. 2 is a schematic illustration of such a network, for B=4 blocks, 21 to 24, with a length l, each addressed by a partial message 25 of κ=log₂(l) bits. The network is thus characterized by the following parameters:

n: total number of beacon neurons 25 having values (0,1)

B: number of blocks

κ: length of input message for each block

l=n/B=size of block

k=Bκ: length of input messages of the network

Besides, the beacon neurons have binary (0,1) values denoted as {u_{bj}} (b=1 . . . B, j=1 . . . l). The beacons of the different blocks are connected to one another by connections having binary values (0.1) denoted as w_{b}_{₁}ⱼ_{₁}_{b}_{₂}ⱼ_{₂}. There is no connection whatsoever within a same block.

The connections, or links, 27 thus define a physical image of the message considered.

FIG. 3 shows another representation of the network of FIG. 2.

4. Learning

The learning of M messages of a length Bκ is done in two steps:
—1—selection of a beacon neuron among l for each of the B blocks. The way in which this selection is done is described in detail in section 4.2.1. It can be noted that each block has a sufficient number of beacons to represent all the possible sub-messages (l=2^{κ}).
—2—activation (i.e. setting at 1) of the

$$\frac{( B - 1 ) B}{2}$$

connections between the beacon neurons representing the message. Certain of these connections could already exist before the learning of this particular message. In this case, these connections remain at the value 1. Thus, after the learning of M messages, the weight of the connections has taken the value:

$${w}_{{b}_{1} {j}_{1} {b}_{2} {j}_{2}} = min ( {\sum }_{{m = 1}_{{b}_{1} \neq {b}_{2}}}^{M} {u}_{{b}_{1} {j}_{1}}^{m} {u}_{{b}_{2} {j}_{2}}^{m} , 1 ) \qquad ( 5 )$$

The network is therefore purely binary: there is either connection (1) or non-connection (0) between two beacon neurons and the learning is incremental. The acquisition of a new message amounts simply to adding connections to the existing network and no standardization is needed.

According to the argument developed in the introduction, the total number of connections being

$$\frac{( B - 1 ) {n}^{2}}{2 B}$$

with P=2 possible levels, the upper boundary of diversity of learning messages of a length

$$k = B {log}_{2} ( \frac{n}{B} )$$

is:

$${M}_{max} = \frac{( B - 1 ) {n}^{2}}{2 {B}^{2} {log}_{2} ( \frac{n}{B} )} \qquad ( 6 )$$

For example, with the values n=2048 and B=4, we obtain Mₘₐₓ=42000. For n=8192, the boundary is of the order of 600000.

After the learning of M messages, the density d of the network (i.e. the proportion of connections with a value 1) is:

$$d = 1 - {( 1 - \frac{1}{{l}^{2}} )}^{M} \qquad ( 7 )$$

If M<<l², this density is close to M/l².

The network therefore achieves a distribution of sparse local codes (only one active neuron among l).

It can be noted that the notion of a sparse local code in cognitive sciences is not novel per se (see for example Peter Foldiak, Dominik Endres (2008) Sparse coding. Scholarpedia, 3(1):2984), but the way in which the codes are associated here and the way in which the overall decoding is done, as proposed here below, appear to be novel and not obvious.

5. Decoding

The decoding of the network locally makes use of a maximum likelihood decoding for each of the B blocks, which is described in detail in the section 7.5.1 and of a message-passing overall decoding that will be explained in section 7.5.2.

5.1 Local Maximum Likelihood Decoding

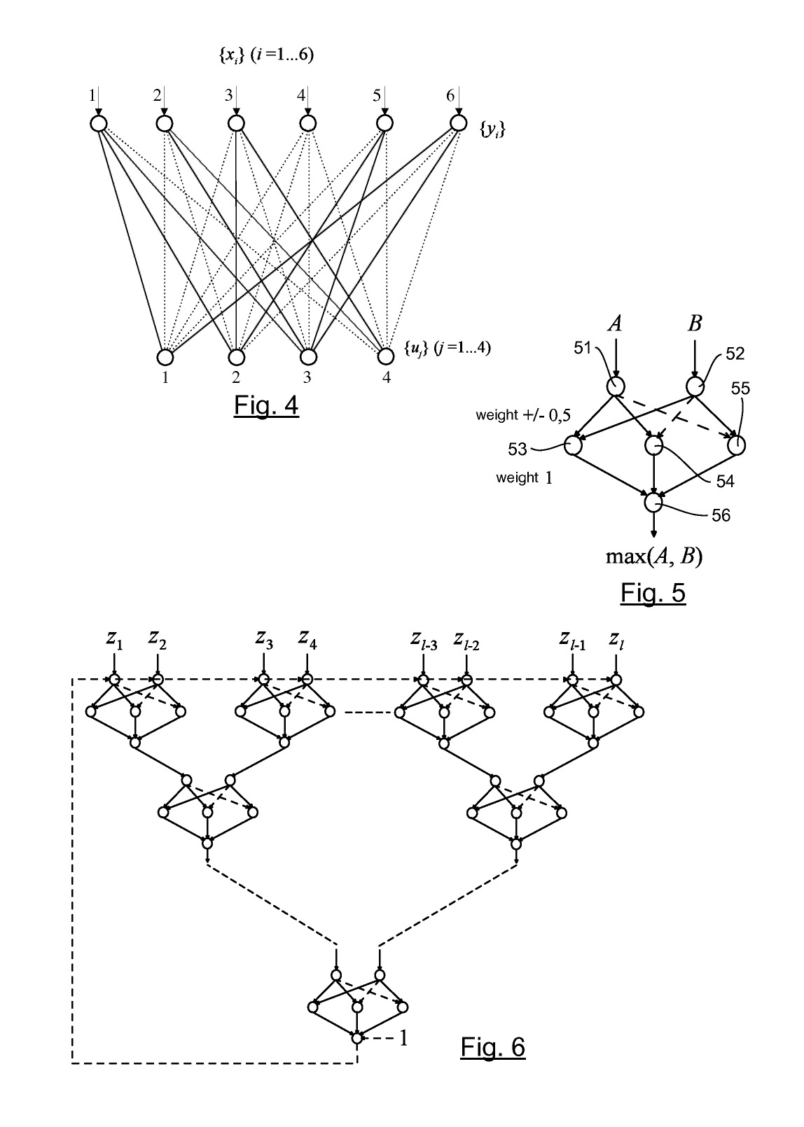

The embodiment described here below is implemented in a context of iterative processing (which is not obligatory, at least in certain applications). This decoding relies on a complete binary bipartite graph, an example of which is given in FIG. 4, for 4 six-bit code words: +1−1−1−1−1+1, +1−1+1−1+1−1, +1+1−1−1+1+1, −1+1+1−1−1−1. The unbroken lines correspond to a value +1, and the dashes correspond to −1.

With the data received, having values {xᵢ} (i=1 . . . κ) that are real values in the most general case, there are associated κ neurons having real values {yᵢ}. On the other side of the graph, l neurons known as “beacon neurons” having binary (0.1) values {uⱼ} (j=1 . . . l), represent the l possible code words. The arcs of the graph tᵢⱼ have the value ±1.

The iterative decoding process can be given by the following equations:

Initialization:

yᵢ⁰=0(i=1 . . . κ)

yᵢ¹=(xᵢ) (8)

For the iteration p (1≦p≦pₘₐₓ):

$$\begin{matrix}{z}_{j}^{p} = {\sum }_{i = 1}^{κ} {t}_{ij} ( {y}_{i}^{p} + γ {y}_{i}^{p - 1} ) ( j = 1 … l ) & ( 9 ) \\ {z}_{max}^{p} = max \{ {z}_{j}^{p} \} & ( 10 ) \\ {u}_{j}^{p} = 1 if {z}_{j}^{p} = {z}_{max}^{p} and if {z}_{max}^{p} > σ \\ {u}_{j}^{p} = 0 if not & ( 11 ) \\ {v}_{i}^{p} = {\sum }_{j = 1}^{l} {t}_{ij} {u}_{j}^{p} & ( 12 ) \\ {y}_{i}^{p} = 1 if {v}_{i}^{p} > 0 \\ {y}_{i}^{p} = - 1 if {v}_{i}^{p} < 0 \\ {y}_{i}^{p} = 0 if not & ( 13 )\end{matrix}$$

γ is a memory effect coefficient that enables the preservation, at the rank p of the iterative process, of a fraction of the result obtained at the rank p−1. This memory effect is indispensible when several codes are associated in a neural network with distributed encoding but should not be exaggerated to prevent errors from sustaining each other in the information exchanges between local decoders or again to prevent unlearned patterns from being recognized by the decoder. It will be noted that the equations (10) and (11) permit the activation of several maximum value beacon neurons, which can be the case for example when one or more input values xᵢ are erased.

σ is the threshold of activation of the beacon neurons. To obtain a true maximum likelihood decoding, σ must be equal to −∞. Depending on the context, it is possible to give a σ finite values, i.e. to impose a low limit of activity on the beacon neurons. For example, in taking σ=0 in the situation where all the input data are erased, the condition zₘₐₓ^{p}>0 of (11) maintains all the beacon neurons at the zero value. This algorithm can therefore achieve a sort of weighted output decoding, capable of considering totally or partially erased messages.

5.2 Overall Decoding of the Network

The decoding of the distributed encoding network (including the local decoding operations) relies on the following algorithm where {d_{bi}} (b=1 . . . B, i=1 . . . κ) is the input/output vector and {tᵢⱼ} is the bipartite graph (−1,1) linking, for each of the blocks, the input data to the beacon neurons (cf. 7.51):

$$\begin{matrix}{z}_{bj} = {\sum }_{i = 1}^{κ} {t}_{ij} {d}_{bi} ( b = 1 … B , j = 1 … l ) & ( 15 ) \\ {z}_{b , max} = max \{ {z}_{bj} \} & ( 16 ) \\ {u}_{bj} = 1 if {z}_{bj} = {z}_{b , max} and if {z}_{b , max} > σ \\ {u}_{bj} = 0 if not & ( 17 ) \\ {v}_{bj} = {\sum }_{{{b}^{′} = 1}_{{b}^{′} \neq b}}^{B} {\sum }_{{j}^{′} = 1}^{l} {w}_{{bjb}^{′} {j}^{′}} {u}_{{b}^{′} {j}^{′}} + γ {u}_{bj} & ( 18 ) \\ {v}_{b , max} = max \{ {v}_{bj} \} & ( 19 ) \\ {u}_{bj} = 1 if {v}_{bj} = {v}_{b , max} and if {v}_{b , max} > σ \\ {u}_{bj} = 0 if not & ( 20 ) \\ {d}_{bi} = {\sum }_{j = 1}^{l} {t}_{ij} {u}_{bj} ( b = 1 … B , i = 1 …κ ) & ( 21 )\end{matrix}$$

In repeating the processing between the equations (18) and (20), the process can become iterative. The necessity of the iterations is not always proven. This can be beneficial when the network is used as an associative memory, with numerous erasures or errors in the input data {d_{bi}} and/or when B is great. If the network is called upon to carry out a function of recognition of the go/no go type (recognition of a learned message or discarding of a non-learned message), a single passage is enough.

In the same way as in the relationship (9), the parameter γ used in (18) is a coefficient that introduces a memory effect, which shall be taken to be equal to 1 here below. This memory effect ensures that a learned message, if it is present at the input of the network without any alteration, is always recognized. The totality of the output binary values (relationship (21)) is then equal to the input data.

5.3 Simplified Presentation of the Decoding

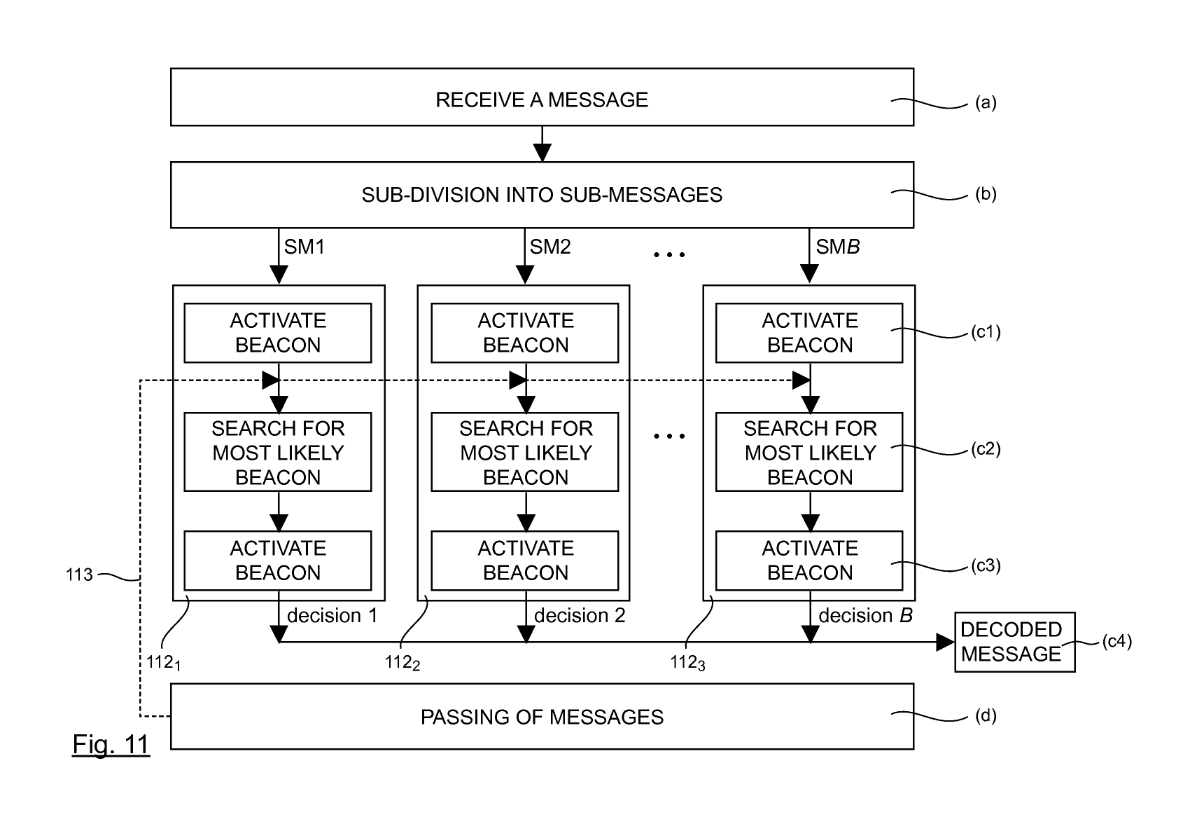

FIG. 11 summarizes and generalizes the decoding method of the invention in a simplified way according to one particular embodiment.

This method first of all comprises a step (a) for receiving a message 111 to be processed. This message 111 is generally constituted by a set of real values (representing, in principle, bits constituting the original message which must be recognized and which could have been deteriorated, for example following a transmission in a disturbed channel).

At a step (b), the message 111 is sub-divided into B sub-messages SM1 to SMB. Each sub-message SMi corresponds to one of the B blocks of the neural network and is processed for a corresponding local decoding 112i (called a step (c)).

This step (c) first of all comprises a step of initialization (c1) in which it activates (passage to the “on” state) the beacon corresponding to the sub-message delivered by the step (b). All the other beacons of the concerned block are “off”. In certain cases however, it is possible for several beacons to be “on” simultaneously.

In a step (c2), a search is then made for the most likely beacon, for example by means of the equations presented here above. In a step (c3), this most likely beacon is activated and the other beacons are extinguished.

Again, in certain situations, several beacons can be the most likely beacons, and remain activated.

Thus, for each block, a decision i is obtained enabling the rebuilding (c4) of a decoded message.

When one or more iterations are desired, an overall decoding step (d) provides for the passage of the decisions on the decoded message so that they are reintroduced (113) into the local decoding operations at the step (c2). The steps (c2) to (c4) are then repeated.

In the case of reiterations, and as explained further above, a memory effect can be introduced to take account of the decisions taken during at least one previous iteration.

6. Neural Implementation of the Search for a Maximum

One way of implementing the “maximum” function in a neural network is deduced from the following equivalents for any two numbers A and B:

$$max ( A , B ) = \frac{A + B}{2} + \vert \frac{A - B}{2} \vert \qquad ( 14 )$$

Using zero threshold neurons, as in the equations (2), but output values (0,1) instead of (−1,1), equivalence (14) can be achieved with the circuit of FIG. 5 provided that at least one of the two inputs is positive or zero.

This circuit therefore comprises:
a first neuron 51 capable of receiving a first value A;
a second neuron 52 capable of receiving a second value B, at least one of said first value A and second value B being positive or zero;
a third neuron 53, connected to the first neuron by a connection with a weight 0.5 and to the second neuron by a connection with a weight 0.5;
a fourth neuron 54 connected to the first neuron by a connection with a weight 0.5 and a second neuron by a connection with a weight −0.5;
a fifth neuron 55 connected to the first neuron by a connection with a weight −0.5 and a second neuron by a connection with a weight 0.5;
a sixth neuron 56 connected to the third, fourth and fifth neurons by connections with weights 1 and delivering the maximum value between the values A and B.

The circuit of FIG. 6 extends the search and selection of the maximum to a number l of parameters {zⱼ} to be compared equal to a power of 2. At least one of the two parameters is positive or zero and the succession of layers of comparators identical to that of FIG. 4 leads to the selection of max {zⱼ}. From this maximum, the value 1 is subtracted and the result is sent back towards the neurons of the first layer as a negative input. Through this return, only the neurons whose inputs are at the maximum value remain active (output equal to 1).

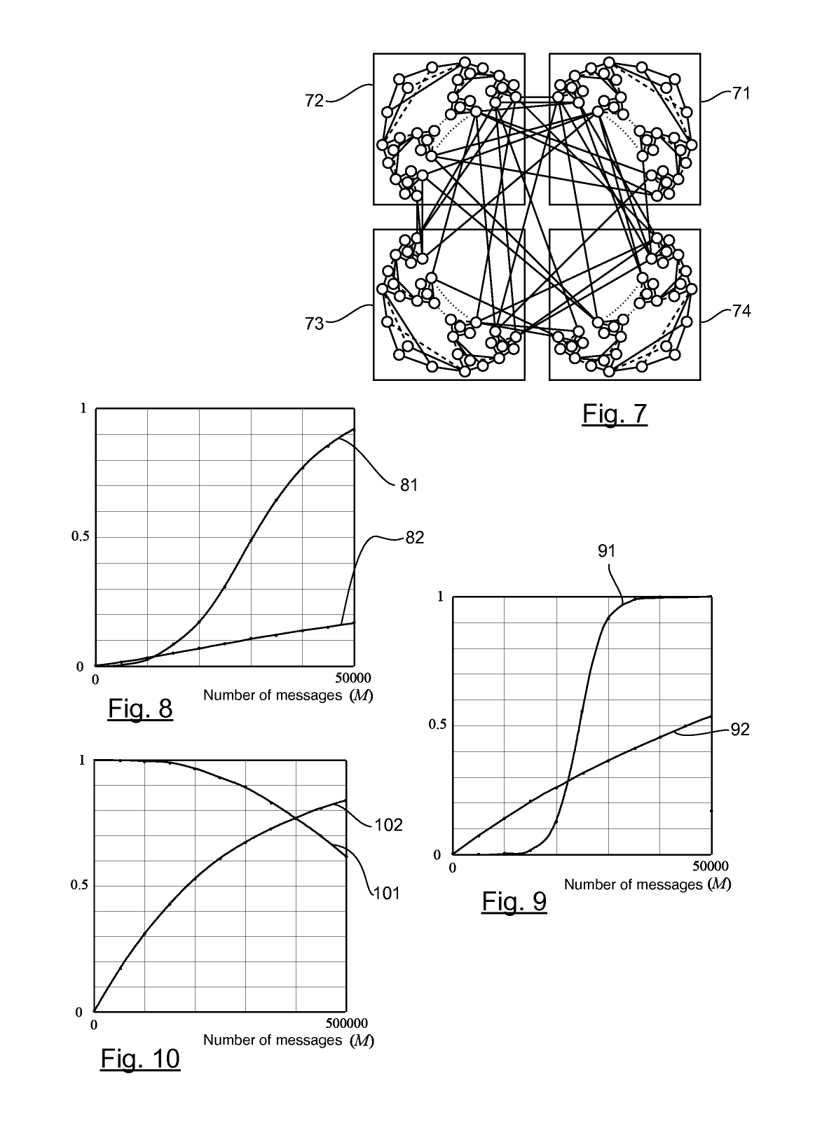

FIG. 7 illustrates an example of a complete neural network, using this structure again in the case of four blocks 71 to 74.

7. Examples of Applications

7.1 Neural Network with Distributed Encoding as an Associative Memory

Let it be assumed that the inputs of one of the blocks is erased and that the other B−1 other blocks are addressed without errors. Then, according to the equations (18) to (20) and after an iteration, the probability that the final neuron correctly representing the erased block is the only activated one is:

P₁=(1−d^{B-1})^{l-1} (22)

Besides, the probability that none of the other blocks has a beacon neuron modified is:

P′₁=((1−d^{B-2})^{l-1})^{B-1} (23)

if the memory effect is not used (γ=0) and is equal to 1 if not. Assuming that the memory effect is used, the probability of error in the overlapping of the integer message is:

P_{e,1}=1−P₁=1−(1−d^{B-1})^{l-1}

or again, according to (7):

$${P}_{e , 1} = 1 - {( 1 - {( 1 - {( 1 - \frac{1}{{l}^{2}} )}^{M} )}^{B - 1} )}^{l - 1} \qquad ( 24 )$$

For small values of M (M<<1²) and for l>>1, P_{e,1} is indeed estimated by:

$${P}_{e , 1} \approx {l ( \frac{M}{{l}^{2}} )}^{B - 1} \qquad ( 25 )$$

More generally, when B_{eff}<B blocks are erased, the probability of error is:

$${P}_{e , {B}_{eff}} = 1 - {( 1 - {( 1 - {( 1 - \frac{1}{{l}^{2}} )}^{M} )}^{B - {B}_{eff}} )}^{( l - 1 ) {B}_{eff}} \qquad ( 26 )$$

For M<<l² and l>>1, P_{e,B}_{_{eff}} is indeed estimated by:

$${P}_{e , {B}_{eff}} \approx {{lB}_{eff} ( \frac{M}{{l}^{2}} )}^{B - {B}_{eff}} \qquad ( 27 )$$

FIG. 8 provides the result of simulations performed (only one iteration) on a network of four blocks of 512 beacon neurons (k=4κ=36 bits), when one of the blocks receives no information. More specifically, this FIG. 10 presents:
the error rate 81 for reading (after only one iteration) M messages of k=36 bits by a network of B=4 blocks of l=512 neurons, when one of the blocks receives no information;
the density of the network 82 (relationship (7)).

The acceptable error rate truly depends of course on the application. If it is sought to design bio-inspired intelligent machines, an error rate of 0.1 can be appropriate. It is possible, on the basis of (27) and in setting an error rate of P_{e,B}_{_{eff}}=P₀, with half of the erased blocks (B_{eff}=B/2), to verify that the number of blocks Bₒₚₜ which maximizes the quantity of messages learned is:

$${B}_{opt} = n int ( log ( \frac{n}{2 {P}_{0}} ) ) ( natural logarithm ) \qquad ( 28 )$$

FIG. 9 gives the result of the simulations made (with four iterations at most) on a network of eight blocks of 256 beacon neurons (k=8κ=64 bits), when half of the sub-messages are erased. More specifically, this FIG. 11 shows:
the error rate 91 of reading (after four iterations) M messages of k=64 bits by a network of B=8 blocks of l=256 neurons, when half of the blocks receive no information. It is observed, as compared with the curve of FIG. 10, that the slope is more pronounced because the number of blocks (eight instead of four) is greater (cf. relationships (26) and (27));
the density of the network 92 (relationship (7)).

A machine of this kind with about 2000 neurons (or roughly the complexity of a neocortical column), with 1.8 10⁶ binary connections can therefore learn and retrieve almost certainly up to any unspecified 15000 messages with 64 bits, half of them erased.

Naturally, to the complexity of the network connecting the beacon neurons to one another, it is necessary to add the complexity of the local decoders responsible for determining the maximum values of activity and connecting beacons and sub-messages. However, these local decoders that have connections established once and for all and are far less numerous than those of the main network do not play a role in the counting of the information connections.

By comparison, with the same number of information connections available, a Hopfield network is capable of acquiring and remembering about 250 messages of 1900 bits. The connections therein are represented on 8 bits instead of 1 in the case of the distributed encoding network, which is the object of an embodiment of the invention. The gain in learning diversity is therefore of the order of 60 and the memorizing efficiency (i.e. the ratio between the memorizing capacity and the quantity of information needed for the storage of the messages) passes from 3.3 10⁻² for the Hopfield network to 53.3 10⁻² for the distributed encoding method.

7.2 Neural Network with Distributed Encoding as a Discriminator

Another possible application of the sparse network is classification. Here, we consider a simple problem of discrimination between messages learned and messages not learned. Let us take a network that has learned a certain number of messages and to which a randomly drawn message is submitted (there are 2^{k} possible such messages, far more than the number of messages learned). Let P_{c} be the probability after an iteration that activated beacon neurons will have c connections with B−1 other beacons activated by this false message (c≦B−1):

$${P}_{c} = ( \begin{matrix}B - 1 \\ c\end{matrix} ) {{d}^{c} ( 1 - d )}^{B - 1 - c} \qquad ( 29 )$$

Let also P′_{c} be the probability that one of the beacon neurons has less than c connections with B−1 other beacons activated by the false message:

$${P}_{c}^{′} = {\sum }_{s = 0}^{c - 1} {P}_{s} \qquad ( 30 )$$

An activated beacon will remain active if the number of connections plus the value γ of the memory effect is strictly greater than the number of connections of each of the other neurons of the same block. The probability of this is:

$${P}_{f , 1} = {\sum }_{c = 0}^{B - 1} {{P}_{c} ( {P}_{c + γ}^{′} )}^{l - 1} \qquad ( 31 )$$

Finally, the probability that B channels all remain active is:

P_{f}=(P_{f,1})^{B} (32)

which gives the formula:

$${P}_{f} = {( {\sum }_{c = 0}^{B - 1} {{P}_{c} ( {\sum }_{s = 0}^{c + γ - 1} {P}_{s} )}^{l - 1} )}^{B} \qquad ( 33 )$$

FIG. 10 gives the result of a simulation performed (with a single iteration) on a network of four blocks of 512 beacon neurons (k=4κ=36 bits), when M messages have been learned and when any unspecified message is submitted to the network. This message is rejected (i.e. the response of the network is different, on a binary value at least, from the message applied) with a very high probability up to values for M of the order of 150000. As for the learned (valid) messages, they are all recognized whatever the value of M because of the memory effect (relationship (18)).

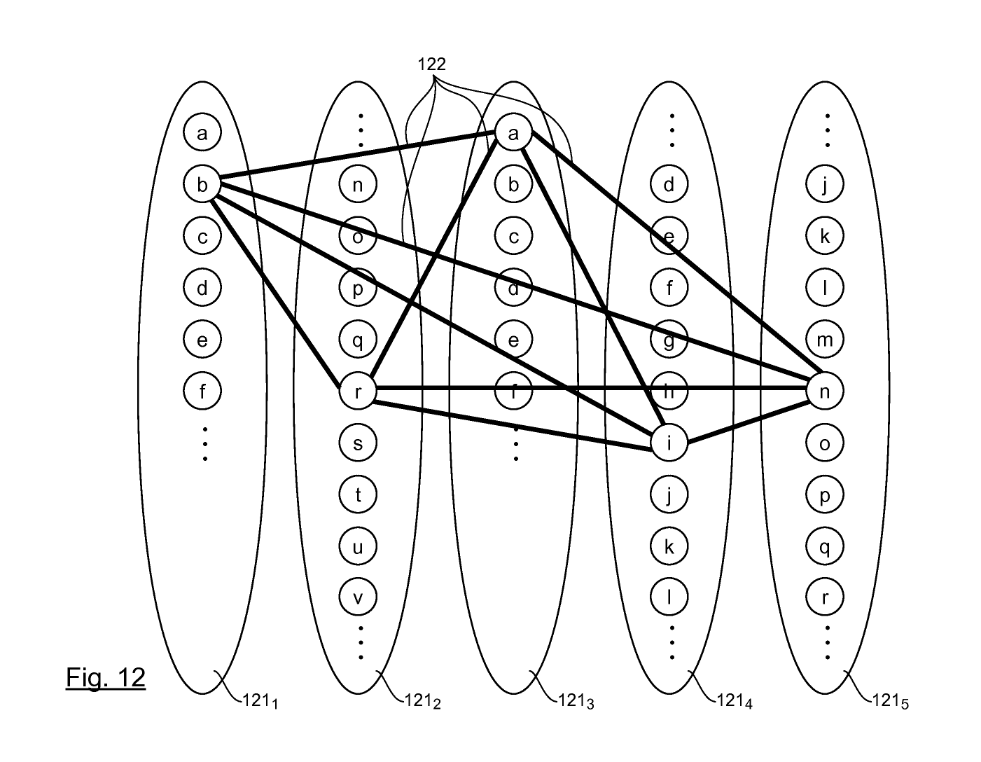

More specifically, this FIG. 12 shows:
the rejection rate 101 (after a single iteration) of any unspecified message when M messages of k=36 bits have been learned by a network of B=4 blocks of l=512 neurons. On the contrary, all the valid messages are recognized by the network whatever the value of M;
the density of the network 102 (relationship (7)).

8. Example of Application to a Non-Binary Finite Alphabet

In the embodiment described here above, binary messages, constituted by a set of bits, are processed. However, a network according to an embodiment of the invention can more generally learn messages constituted by a collection of B symbols drawn from a finite alphabet (for example the figures of the decimal system or the letters of the alphabet).

To this end, it is planned that each block will contain as many beacon neurons (l) as there are symbols in this alphabet. Assuming that l is a power of 2, by simplification, each beacon can be addressed by a sub-message of κ=log₂(l) bits. In other words, all the 2^{log}^{₂}^{(l)}=l sub-messages of log₂(l) bits are possible and the complete messages processed by the network have a length k=B.κ bits.

The learning of messages constituted by symbols (and no longer by binary messages) is illustrated by the example of FIG. 12. In this embodiment, the symbols are letters belonging to the Roman alphabet. What is to be done for example is to memorize words or sequences of letters.

In FIG. 12, five blocks 121₁ to 121₅ are illustrated (more generally, the number of blocks will depend on the maximum size of the words to be memorized). They each contain 26 local beacons respectively associated with the 26 letters of the Roman alphabet. To memorize the word “brain”, five channels are then turned on in each block:
block 121₁: beacon associated with the letter “b”;
block 121₂: beacon associated with the letter “r”;
block 121₃: beacon associated with the letter “a”;
block 121₄: beacon associated with the letter “i”;
block 121₅: beacon associated with the letter “n”,
   and the corresponding connections 122 are created to form a pattern with five vertices corresponding to the “on” beacons and all connected to one another.

In graph theory, a sub-set of B nodes all connected to one another is generally called a clique. FIG. 12 thus illustrates a clique with 5 vertices, or a 5-clique. According to an embodiment of the invention, the messages are therefore learned in the form of cliques, of which the vertices all belong to different blocks.

9. Examples of Implantation

An embodiment of the invention can be implemented in different ways. In particular, it can be made in the form of a data-processing device and for example implanted directly into an integrated circuit or a micro-circuit (or several of them).

It can also be made in software form, entirely or in part. It can then take the form of a complete program for implementing a neural network or the form of two programs respectively carrying out learning and decoding.

It is also possible for the learned neural network to be shared and/or distributed. It is thus possible for the neural network to be stored on a remote site accessible for example via the Internet or a private network, and for it to be interrogated remotely by a computer or any other apparatus equipped with a processing treatment. This makes it possible especially to optimize and secure the preservation of data and if necessary makes it possible to share the learning and/or the decoding among several machines or users.

At least one embodiment of the present disclosure provides a technique for simply and efficiently increasing the diversity of learning of a neural network.

At least one embodiment provides a technique of this kind offering a high memorizing capacity especially in the presence of erasure.

At least one embodiment provides a technique of this kind having high capacity of discrimination between valid (learned) messages and non-valid messages.

Although the present disclosure has been described with reference to one or more examples, workers skilled in the art will recognize that changes may be made in form and detail without departing from the scope of the disclosure and/or the appended claims.

1. A device for learning messages, implementing a neural network, wherein the device comprises:
a set of neurons, called beacons, said beacons being binary neurons capable of taking only two states, an “on” state and an “off” state, said beacons being distributed into blocks, each block comprising a predetermined number of beacons; and
means for learning by said neural network, comprising:
means for sub-dividing a message to be learned into B sub-messages to be learned, B being greater than or equal to two, each block of beacons being assigned to processing a sub-message, and each beacon being associated with a specific occurrence of said sub-message;
means for activating a single beacon in the “on” state in each block, for a sub-message to be learned, all the other beacons of said block being in the “off” state; and
means for creating connections between the beacons, activating, for the message to be learned, connections between the “on” beacons of each of said blocks, said connections being binary connections, capable of taking only a connected state and a disconnected state.

2. The device according to claim 1, wherein said messages have a length k=Bκ where B is the number of blocks and κ is the length of a sub-message, each block comprising l=2^{κ} beacons.

3. (canceled)

4. The device according to claim 1, wherein the device is made in the form of at least one integrated circuit.

5. A device for decoding a message to be decoded, by a neural network wherein the device for decoding comprises:
means for sub-dividing the message to be decoded into B sub-messages to be decoded, B being greater than or equal to two, each sub-message being processed by a block comprising a predetermined number of neurons, called beacons, said beacons being binary neurons capable of taking only two states, an “on” state and an “off” state, and each beacon being associated with a specific occurrence of said sub-message;
means for turning “on” the beacons associated respectively with said sub-messages to be decoded, in the corresponding blocks, all the other beacons of said blocks being in the “off” state; and
means for associating, with said message to be decoded, a decoded message as a function of said “on” beacons and of connections created between the “on” beacons of each of said blocks, said connections being binary connections, capable of taking only a connected state and a disconnected state.

6. The device according to claim 5, wherein said means for associating implement a maximum likelihood decoding.

7. The device according to claim 6, wherein the device for decoding comprises means for local decoding, for each of said blocks, activating in the “on” state at least one beacon that is the most likely beacon, in said block, as a function of the corresponding sub-message to be decoded,
and for delivering a decoded sub-message as a function of the connections activated between said beacons in the “on” state.

8. The device according to claim 7, wherein the device for decoding comprises overall decoding means fulfilling a message-passing function in taking account of the set of beacons in the “on” state.

9. The device according to claim 7, wherein the device for decoding is configured to implement an iterative decoding performing at least two iterations of the processing done by said local decoding means.

10. The device according to claim 5, wherein said means for associating implement processing neurons, organized so as to determine the maximum value of at least two values submitted at input.

11. The device according to claim 10, wherein said processing neurons comprise at least one basic module constituted by six zero-threshold neurons and with output values 0 or 1, comprising:
a first neuron capable of receiving a first value A;
a second neuron capable of receiving a second value B, at least one among said first value A and second value B being positive or zero;
a third neuron, connected to the first neuron by a connection with a weight of 0.5 and to the second neuron by a weight of 0.5;
a fourth neuron connected to the first neuron by a connection with a weight of 0.5 and to the second neuron by a connection with a weight of −0.5;
a fifth neuron connected to the first neuron by a connection with a weight of −0.5 and to the second neuron by a connection with a weight of 0.5;
a sixth neuron connected to the third, fourth and fifth neurons by connections with a weight of 1 and delivering the maximum value between the values A and B.

12. The device according to claim 5, wherein the device for decoding is made in the form of at least one integrated circuit.

13. A method comprising learning by a neural network, wherein learning comprises:
implementing a set of neurons, called beacons, said beacons being binary beacons, capable of taking only two states, an “on” state and an “off” state, said beacons being distributed into blocks, each block comprising a predetermined number of beacons; and
a phase of learning comprising the following steps for a message to be learned:
a step of sub-dividing a message to be learned into B sub-messages to be learned, B being greater than or equal to two, each block of beacons being allocated to processing a sub-message, each beacon being associated with a specific occurrence of said sub-message;
a step of activating a single beacon in the “on” state in each block, for a sub-message to be learned, all the other beacons of said block being in the “off” state; and
a step of creating connections between the beacons, activating, for the message to be learned, connections between the “on” beacons of each of said blocks, said connections being binary connections, capable of taking only a connected state and a disconnected state.

14. The method according to claim 13, wherein in said step of activating, a connection between two beacons possessing the value 1 keeps this value.

15. A non-transitory computer-readable carrier comprising a computer program product or stored thereon and executable by a processor, the program product comprising program code instructions configured to perform, when executed by the processor, a method for learning by a neural network and implementing a set of neurons, called beacons, said beacons being binary beacons, capable of taking only two states, an “on” state and an “off” state, said beacons being distributed into blocks, each block comprising a predetermined number of beacons, wherein the instructions comprise:
instructions configured to implement a phase of learning comprising the following steps for a message to be learned:
a step of sub-dividing a message to be learned into B sub-messages to be learned, B being greater than or equal to two, each block of beacons being allocated to processing a sub-message, each beacon being associated with a specific occurrence of said sub-message;
a step of activating a single beacon in the “on” state in each block, for a sub-message to be learned, all the other beacons of said block being in the “off” state; and
a step of creating connections between the beacons, activating, for the message to be learned, connections between the “on” beacons of each of said blocks, said connections being binary connections, capable of taking only a connected state and a disconnected state.

16. A method comprising: decoding a message to be decoded by a neural network, wherein decoding a message comprises the following steps:
a) receiving a message to be decoded;
b) sub-dividing said message to be decoded into B sub-messages to be decoded, B being greater than or equal to two, each sub-message being processed by a block comprising a predetermined number of neurons, called beacons, said beacons being binary neurons capable of taking only two states, an “on” state and an “off” state, and each beacon being associated with a specific occurrence of said sub-message; and
c) associating, with said message to be decoded, a decoded message as a function of the “on” beacons corresponding to said sub-messages to be decoded.

17. The method according to claim 16, wherein said step (c) comprises, for each of said sub-messages to be decoded, and for each corresponding block of beacons, the sub-steps of:
c1) initializing, by activating in the “on” state at least one beacon corresponding to the processed sub-message, and extinguishing all the other beacons of said block;
c2) searching for at least one most likely beacon from among the set of beacons of said block; and
c3) activating, in the “on” state, said at least one most likely beacon, and extinguishing of all the other beacons of said block;
and a step of:
c4) determining the decoded message corresponding to the message to be decoded, by combination of the sub-messages designated by the beacons in the “on” state.

18. The method according to claim 17, wherein decoding a message comprises a step:
d) of passing messages between the B blocks, adapting the values of the beacons for a reinsertion at the step (c2),
said steps c2) to c4) being then reiterated.

19. The method according to claim 18, wherein, during a reiteration, the step c2) take account of pieces of information delivered by the step c4) and pieces of information taken into account during at least one preceding iteration.

20. The method according to claim 19, wherein said pieces of information taken into account during at least one preceding iteration are weighted by means of a memory effect coefficient γ.

21. The method for decoding according to claim 18, wherein, in the step c3), a most likely beacon is not activated if its value is below a predetermined threshold σ.

22. The method according to claim 17, wherein, for a message to be decoded, the step of decoding delivers:
a decoded message corresponding to the message to be decoded so as to provide for an associative memory function; or
a piece of binary information indicating whether or not the message to be decoded is a message already learned by said neural network so as to provide a discriminating function.

23. The non-transitory computer-readable carrier according to claim 15, further comprising program code instructions stored thereon and configured to perform a method of decoding a message to be decoded by the neural network configured according to the step of learning, when executed by the processor, wherein decoding a message comprises the following steps:
a) receiving a message to be decoded;
b) sub-dividing said message to be decoded into B sub-messages to be decoded; and
c) associating, with said message to be decoded, a decoded message as a function of the “on” beacons corresponding to said sub-messages to be decoded.
